(19) United States
(12) Patent Application Publication
(10) Pub. No.: US 2008/0192309 A1
(43) Pub. Date: Aug. 14, 2008

(54) COLOR SCAN CORRECTION METHOD AND SYSTEM

(75) Inventor: Zhen He, Sherwood, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/673,327

(22) Filed: Feb. 9, 2007

(51) Int. Cl. H04N 1/60

(52) U.S. Cl. 358/518

(57) ABSTRACT

Scanners typically capture image data in a device-dependent RGB space, after which the signal is converted to a device-independent color space. The color data capture and calibration is often not sufficiently accurate and sometimes leads to a visible color difference in hardcopy output. Methods for improving the accuracy include scanning a document into RGB image data, converting the image data of the scanned document into a first device-independent color space, applying a correction transform to modify the image data in the first device-independent color space to reduce the error in the image data, and mapping the modified coordinates to a second output color space for printing.

The embodiments disclosed herein relate to a color control system, and more specifically, a system that corrects for inaccurate scanner calibration.

Color calibration and control are very important to document reproduction devices. The generation of color copies can be thought of as a two step problem: first, the generation of an image, for example, by scanning an original document with a color image input terminal or scanner, and second, printing of that image with a color printer in accordance with colors defined by the scanner or computer generated image. During the process between scanning and printing, various problems can cause noticeable flaws in the color of a printed document.

More specifically, the scanner and/or scanning process can be a source of imperfections in printed copies. When a user inputs a document to a device scanner, the scanner creates a representation of the document image(s) in RGB space. The RGB representation is then mapped into a device-independent space such as CIEL*a*b* through a scanner calibration process. After image processing applications, if any, act upon the device-independent representation, the device-independent representation is then mapped into CMYK space, the output space of the printer, for printing. However, the scanner often does not accurately create a representation of a scanned document in device-dependent RGB space due to imperfections in the scanner and scanning process and the subsequent scanner calibration process may not be sufficient to compensate for the scanner inaccuracy. These imperfections can result in visible color shifts in the hardcopy output.

One approach that can be taken is to first measure the device-independent color values (e.g., CIEL*a*b* values) of a target original consisting of color patches. Then the intermediate image of the target before CIEL*a*b* to CMYK conversion is intercepted. A color space mapping from the intercepted CIEL*a*b* values to the device-independent CIEL*a*b* values is established with a 3-D look-up-table (LUT). Finally, the corrected CIEL*a*b* values are used as the input to a CIEL*a*b* to CMYK conversion module.

Embodiments include a method for copying documents. The method includes scanning a document, capturing image data from the document, and generating a first signal in a device-dependent color space. The method further includes converting the first signal of the scanned document from the device-dependent color space to a second signal in a device-independent color space, modifying the second signal in the device-independent color space to reduce errors in the signal introduced during the steps of scanning and capturing the image data, and converting the modified second signal to a third signal in an output color space for printing.

Embodiments also include a method for generating a color correction mapping for image data. The method includes scanning a document containing one or more color images, converting the color data into a signal in a device-independent color space, intercepting the signal, generating a first set of data points from the intercepted signal, measuring a second set of more precise data points, wherein each of the second set of more precise data points corresponds to one of the first set of data points, and interpolating the color data in the intercepted signal to help find the more precise data points that correspond to the remaining intercepted data points in the intercepted signal.

Embodiments also include an apparatus including a scanner for generating a first signal in a device-dependent color space containing color information, a first color space converter for converting the first signal into a second signal in a device-independent color space, a corrective transform module for transforming the second signal into a third signal in the device-independent color space to reduce the device-dependency of the second signal, a second color space converter for converting the third signal to a fourth signal in a device-dependent output color space, and a print engine.

Various exemplary embodiments will be described in detail, with reference to the following figures.

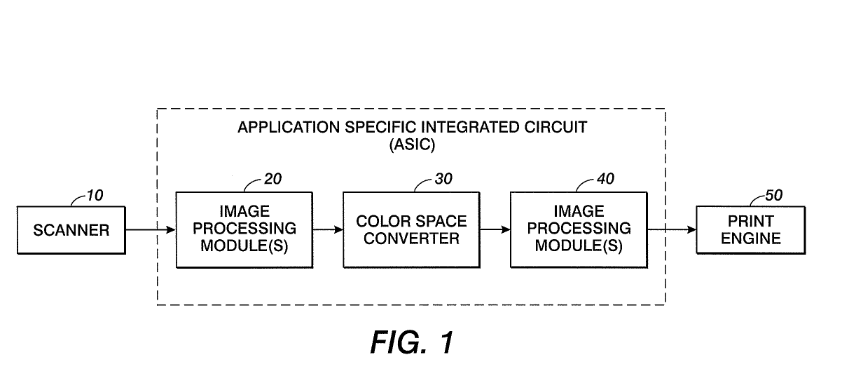

FIG. 1 schematically illustrates an exemplary image path for a copying device.

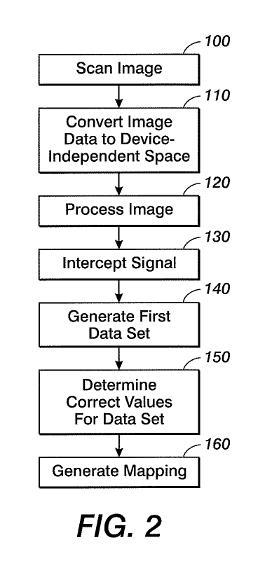

FIG. 2 is a flowchart describing the generation of a transform to correct device-dependent errors in a device-independent space.

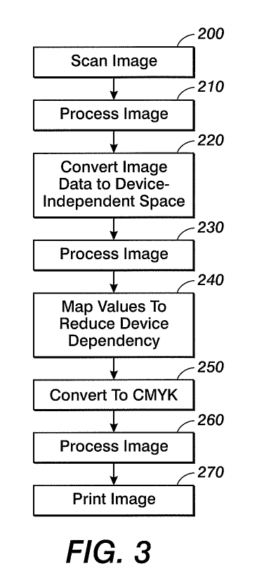

FIG. 3 is a flowchart describing a color calibration/control system.

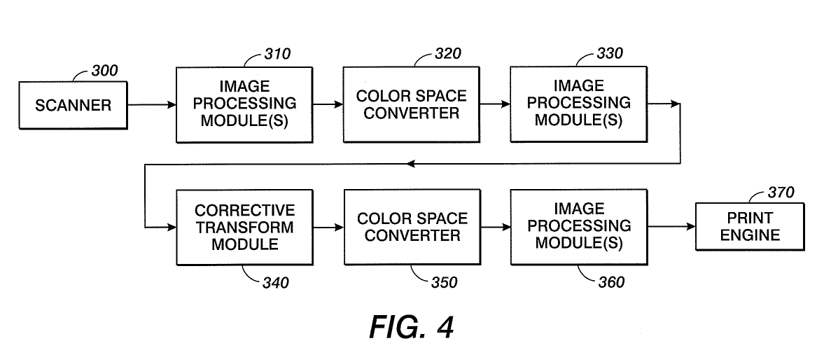

FIG. 4 is a revised and more detailed image path for a copying device including the image data correction of FIG. 1.

A “copying device” as referred to herein refers to any device that includes a scanner and is capable of producing hardcopy output. Copying devices include, for example, copiers and multi-function devices. Hardcopy output refers to any markable media such as, for example, paper, plastic, and textile materials.

A “document” as referred to herein includes one or more pages of data in a scannable format. A document can include, for example, images and/or text.

Color copying and reproduction is a valuable tool in the world today. Many color documents are scanned and reproduced every day. In the absence of user instructions to the contrary, it is generally desirable that the color scheme of a printed document resemble its scanned original document as closely as possible. To help maintain a high correlation between input and output, color copying devices usually include some sort of calibration and/or control programming.

Referring now to the drawings where the showings are for the purpose of describing an embodiment of the invention and not for limiting same, FIG. 1 schematically illustrates an exemplary image path for a copying device. Copying devices (including multi-function devices) include a scanner 10 for inputting documents and a print engine 50 for reproducing those documents. The scanner 10 captures the image data including color data in a device-dependent scanner space. The scanner output signal is transformed into a device-independent space such as, for example, CIEL*a*b*, where it may pass through a series of image processing modules 20 (e.g., scaling, edge segmentation, smoothing, edge sharpening, etc) before reaching a color space converter 30—for example, a LUT module which converts the CIEL*a*b* signal to a device-dependent CMYK signal. More image processing modules 40, including, for example, a halftoning process, may process the CMYK signal and finally the processed CMYK data is sent to the device's print engine 50. In embodiments, the image processing modules 20, 40 and the color space converter 30 are all co-located on a single ASIC.

An original color document that is fed into the scanner 10, results in a set of scanner image signals R_{S}, G_{S}, B_{S}, (or scanner-RGB) defined in device-dependent scanner terms. A post-scanning processor uses a scanner calibration transform to provide a transformation of scanner image signals R_{S}, G_{S}, B_{S} into a device-independent color space such as, for example, CIEXYZ. In embodiments, the post-scanning processor is part of a separate module or chip (e.g., the ASIC illustrated in phantom in FIG. 1) receiving the scanner output signal. The scanner calibration transform is typically a linear transform, which can be represented by an optimized 3×3 matrix. A scanner calibration system may also process the image before it is converted to device-independent space such as, for example, by applying a gray-balance TRC to the scanner-RGB data. Such processing may also be part of the post-scanning processor. After transformation into CIEXYZ space (or other linear color space), the image signals are then transformed into a uniform color space such as, for example, CIEL*a*b.

Due to a variety of reasons, the transformation from device-dependent to device-independent to device-dependent space sometimes results in reproduced images with visible color discrepancies. One source of such errors in color output is the scanning process. Problems can arise because of problems with the capture of image color data in scanner-RGB space and the transformation of that data into a “device-independent” space. Due to imperfections in the scanning and/or calibration process, “device-independent” color space values are not always truly device-independent. Therefore, for example, the scanner output signal in CIEL*a*b* space can be noticeably device-dependent rather than device-independent. As previously stated, this can lead to visible color discrepancies between the printed, final documents and the original, scanned documents.

For example, CCD sensors in the scanner 10 typically generate a representation of the scanned document in device-dependent scanner-RGB space. The CCD sensors are designed to approximate human visual response. However, the response of the CCD sensors often does not precisely match the response of the cones in the human eye. In many cases, the response of these CCD's is not a linear transform of human vision color space. Therefore, the device-dependent RGB-scanner space is typically not a linear transform of the human vision color space.

One method to help correct errors introduced by the scanner or scanning process is to assume the converted scanner data is not actually device-independent and generate another mapping to transform the device-dependent CIEL*a*b* signal into a device-independent signal prior to converting the image color data into the device-dependent, CMYK output space. In embodiments, this added mapping can be folded into a modified LUT.

One way to generate a transform from the device-dependent signal in CIEL*a*b* space into a device-independent signal in CIEL*a*b* space is to compare known device-independent color space values of a document with the actual values prior to conversion to CMYK space. A spectrophotometer, for example, such as, for example, a Spectrolino Gretag, can measure the correct device-independent values for a scanned document. The actual values embodied in the scanner output signal can be found by intercepting the device-dependent signal prior to conversion to CMYK space. From the measured values, a set of data points, labₘ, can be generated, and from the intercepted signal, a set of data points, labᵢ, can be measured. The set of data points (labᵢⱼ, labᵢⱼ) (where “the subscript “j” is simply used to denote each corresponding pair of points) can then be used to create a mapping from the device-dependent values to the device-independent values.

The conversion from a device-independent space to the device-dependent CMYK space may be denoted as f( ) and typically takes the form of a LUT. If the set of points labᵢ is labeled g₁, and the set of points labₘ is labeled g₂, then what is sought is a mapping ho that will map g₁ to g₂, so that f(h(g₁)) will yield the correct CMYK output values. Once h( ) is known it can be applied to the sensor output image signal prior to the conversion from the device-independent working color space to the device-dependent CMYK space. Rather than executing two distinct steps, the correction transform h( ) may be combined with the transformation to the CMYK output space f( ), so that only one transformation, f′( )=f(h( )), is actually performed to map the device-dependent signal in device-independent space to the device-dependent color space of the print engine.

The functions h( ) and f( ) are generally not reducible to linear equations and both typically use interpolation methods based upon the known mappings of a discrete set of points to map a color signal. As noted in the preceding paragraph, f( ) is a LUT. LUT's generally contain the correspondence between a first set of points and a second set of points. Typically, f( ) contains the correspondence between a first set of points in a device-independent color space and a second set of points in a device-dependent color output space. In embodiments, a 17×17×17 grid of points in a device-independent space and their corresponding points in a device-dependent CMYK space form the basis of this LUT. Interpolation methods are used to find the remaining color correspondences and convert a device-independent signal to a device-dependent signal. For example, methods that may be used include those disclosed in U.S. Pat. Nos. 4,275,413, 5,471,324, 5,734,802, 6,441,923, and 7,123,381, (the disclosures of which are hereby incorporated for their teachings with respect color calibration and control, and particularly with regard to methods of interpolation). Similarly, h( ) can be viewed as a mapping within a device-independent color space between the intercepted values and the corrected values of the scanner output signal. Using the known correspondences (labᵢⱼ, labᵢⱼ) with any of a variety of interpolative methods (such as those incorporated previously in this paragraph) a corrected signal may be found from the intercepted signal. In embodiments, between 300 and 400 pairs of intercepted and measured values were used. The number of points used may vary depending on the copying device and the use to which that device is put.

FIG. 2 is a flowchart illustrating the process of generating the transform from a device-dependent signal to a device-independent signal. In step 100, a document is scanned. In step 110 the image color data is transformed into a device-independent color space. In step 120, image processing applications may modify the color data further. In step 130, the signal is intercepted before being converted into a device-dependent CMYK signal. In step 140, a first data set is generated based upon the intercepted signal. In step 150, the correct device independent values for the data set generated in step 140 are determined. These may already be known or may be found through the use of measurement tools, such as the Spectrolino Gretag. Finally, a mapping between the first data set and the correct data set is generated in step 160 using any of a number of computational methods, particularly interpolative methods. The order the steps are presented in FIG. 2 should be considered definitive as some events may occur simultaneously or in alternate order. For example, steps 130 and 150 also should not presumed to be in chronological order as either may be performed before the other.

Once a mapping is found, the mapping can be incorporated into the scanner output signal path. FIG. 3 is a flowchart illustrating a method of the present invention. In step 200 a document is scanned. After scanning, the document signal may be processed 210 while it is still in the device-dependent scanner space. For example, a gray-balance TRC may be applied. After the image processing steps, if any, are performed in the scanner-space, the document signal is converted into a device-independent space 220 such as, for example, CIEL*a*b*. Once converted, the image may be further processed 230. After any further image processing is accomplished, the corrective mapping is applied 240 to reduce, and hopefully remove, the device-dependency contained in the document signal. Then the signal is converted to a device-dependent output signal 250, which is traditionally a CMYK signal. In embodiments, steps 240 and 250 may be combined into a single step. It may be possible to combine the two mappings into one mapping that corrects for the device-dependent qualities of the signal when mapping to the CMYK space. The CMYK signal may then be subjected to another round of image processing 260, before finally being printed 270.

FIG. 4 schematically illustrates an apparatus for carrying out the methods described herein. Please note that many of the functional components I list below may be different functional features of the same component. To begin with, a scanner 300 inputs an image from a document. An image processing module 310 (for example the gray-balance TRC) may then act on the document signal while it is still in the device-dependent scanner-RGB space. After any processing steps are performed, a color space converter 320 transforms the signal into a device-independent space. In embodiments, the image processor 310 and the color space converter 320 may be combined into a single transformation. After the document signal is transformed into device-independent space, one or more additional image processing modules 330 may act upon the signal. Next, a corrective transform module 340 is applied to the document signal to reduce the error in the signal. Another color space converter 350 is then applied to the corrected document signal to transform it into a color output space, such as CMYK space. In embodiments, the corrective transform module 340 and color space converter 350 may be combined into one conversion module that is applied to the document signal. After the document signal is converted more image processing modules 360 may be applied to the document signal. Finally, the document signal is sent to a print engine 370 for printing. The components 330-360 may be separate functions of a single component, such as a processing chip, or may individually be parts of separate components. Further, components 310 and 320 may be a part of the scanner 300, may be embodied in a subsequent integrated circuit (either with or without one or more of the components 330-360), or may be embodied in physically distinct components.

It is important to note that while the mapping disclosed herein should reduce the output errors caused by the scanning process, in many cases, the mapping will not eliminate them entirely.

Various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A method for copying documents, comprising:
scanning a document, capturing image data from the document, and generating a first signal in a device-dependent color space;
converting the first signal of the scanned document from the device-dependent color space to a second signal in a device-independent color space;
modifying the second signal in the device-independent color space to reduce errors in the signal introduced during the steps of scanning and capturing the image data; and
converting the modified second signal to a third signal in an output color space for printing.

2. The method of claim 1, wherein the device-independent color space is ClEL*a*b*.

3. The method of claim 1, wherein the output color space is a CMYK space.

4. The method of claim 1, further comprising processing the second signal before modifying the second signal.

5. The method of claim 1, wherein the steps of modifying the second signal and converting the modified second signal are performed as one step.

6. The method of claim 1, wherein modifying the second signal comprises applying a corrective transform to map the image data to corrected values within the device-independent space.

7. The method of claim 6, wherein the corrective transform is a LUT based upon a finite set of known mappings between data points encoded in the unmodified signal in device-independent space and data points in the modified signal in device-independent space.

8. A method for generating a color correction mapping for image data, comprising:
scanning a document containing one or more color images;
converting the color data into a signal in a device-independent color space;
intercepting the signal;
generating a first set of data points from the intercepted signal;
measuring a second set of more precise data points, wherein each of the second set of more precise data points corresponds to one of the first set of data points; and
interpolating the color data in the intercepted signal to help find the more precise data points that correspond to the remaining intercepted data points in the intercepted signal.

9. The method of claim 8, wherein generating a mapping includes interpolating based upon the first and second known sets of data points.

10. The method of claim 8, wherein the second set of correct data points are found by analyzing a correctly colored image with a spectrophotometer.

11. An apparatus, comprising:
a scanner for generating a first signal in a device-dependent color space containing color information,
a first color space converter for converting the first signal into a second signal in a device-independent color space;
a corrective transform module for transforming the second signal into a third signal in the device-independent color space to reduce the device-dependency of the second signal;
a second color space converter for converting the third signal to a fourth signal in a device-dependent output color space; and
a print engine.

12. The apparatus of claim 11, further comprising at least one image processing module that acts processes the second signal.
